(19) United States
(12) Patent Application Publication
(10) Pub. No.: US 2008/0184166 A1
(43) Pub. Date: Jul. 31, 2008

(54) AIRCRAFT AVIONIC SYSTEM HAVING A PILOT USER INTERFACE WITH CONTEXT DEPENDENT INPUT DEVICES

(75) Inventors: Blake R. Getson, Columbus, OH (US); Clifford S. Brust, Beaver Creek, OH (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: L-3 COMMUNICATIONS AVIONICS SYSTEMS, INC., Grand Rapids, MI (US)

(21) Appl. No.: 11/949,492

(22) Filed: Dec. 3, 2007

Related U.S. Application Data
(63) Continuation-in-part of application No. PCT/US2006/021390, filed on Jun. 2, 2006.
(60) Provisional application No. 60/595,060, filed on Jun. 2, 2005.
(60) Provisional application No. 60/595,355, filed on Jun. 27, 2005.

(51) Int. Cl. G06F 3/048

(52) U.S. Cl. 715/810; 715/860

(57) ABSTRACT

An avionics system having a pilot user interface, and method of interfacing with a pilot, includes providing a display screen and a video processor driving the display screen. A plurality of context dependent input devices is provided. Operation of at least one of the input devices may cause the processor to display a rotary selection list on the display screen. The rotary selection list includes multiple potential selections, each capable of effecting a change in the avionic system when highlighted. At least one of the input devices may be made up of at least one rotary knob. The processor displays a context dependent label for the rotary knob.

### CROSS-REFERENCE TO RELATED APPLICATIONS

This application is a continuation-in-part of, and claims priority to, international patent application PCT US/2006/021390 having an international filing date of Jun. 2, 2006, which in turn claims priority to U.S. provisional applications 60/595,060 filed Jun. 2, 2005 and 60/595,355 filed Jun. 27, 2005, the complete disclosures of which are all hereby incorporated herein by reference in their entirety.

### BACKGROUND OF THE INVENTION

The present invention is directed to an aircraft avionics system for monitoring and controlling aircraft flight parameters and, in particular, to a pilot user interface that provides information to and receives instructions from a pilot.

The pilot interface of known aircraft avionic systems is relatively complex and requires extensive training by the pilot. A trained pilot is able to create a mental picture of what is occurring with the aircraft by monitoring various dials and other indicators. Full-time pilots get extensive training on system operation including recovery from various failure modes.

General aviation pilots, in general, do not necessarily have the level of training of a full-time pilot. As such, it is imperative that the flight controls in general, and especially those used for general aviation pilots, avoid pilot confusion and help the pilot create a mental picture of what is occurring with the aircraft at all times.

### SUMMARY OF THE INVENTION

The present invention is directed to an aircraft avionics system that integrates information together and provides it in a more readable format to the pilot. The present invention provides a pilot user interface with a display screen that is capable of displaying extensive data to the pilot, such as moving maps that place the aircraft so that the pilot can see on a map where the aircraft is located. The display screen may also show terrain so that the pilot can know when the aircraft is close to obstacles. The display screen can integrate tactical instruments that show the state of the aircraft, such as altitude, airspeed, vertical speed, and the like.

An avionics system having a pilot user interface and method of interfacing with a pilot, according to an aspect of the invention, includes providing a display screen and a video processor driving the display screen. A plurality of context dependent input devices is provided. Operation of one of the input devices causes the processor to display a rotary selection list on the display screen. The rotary selection list includes multiple potential selections, each capable of effecting a change in the avionic system when highlighted. According to this aspect of the invention, subsequent operation of the corresponding input device causes a different one of the selections to be highlighted. This allows the pilot to select between options using the rotary selection list that is associated with a particular context dependent input device, such as a context sensitive button or softkey. The rotary selection list is a menu of selectable options. The rotary selection list menu associated with the softkey may remain hidden until the softkey button is actuated. The rotary selection list menu is then displayed (pops up) upon actuation of the softkey button and depicts multiple selections, one of which will be highlighted. By repeatedly pressing the softkey button, the system cycles through the available selections. Advantageously, this allows the pilot at all times to be able to observe the selections that are available to the pilot including other available states without changing the context of the display the pilot is currently in. This allows a shallow menu hierarchy.

An aircraft avionics system having a pilot user interface and method of interfacing with a pilot, according to another aspect of the invention, includes providing a display screen and a video processor driving the display screen. A plurality of context dependent input devices is provided. At least one of the input devices is made up of at least one rotary knob. The processor displays a context dependent label for the rotary knob. The processor displays an editable parameter of the avionics system, wherein the rotation of the rotary knob edits a portion of the parameter or the parameter in total. The rotary knob may be made up of a large rotary knob and a small rotary knob that is smaller than and concentric with the large rotary knob. Rotation of the large rotary knob may be used to edit a most significant portion of the parameter and rotation of the small knob edits the least significant portion of the parameter. In addition, the small knob may be actuatable along its axis of rotation to perform an additional function, such as selection of a particular parameter value. A context dependent label may be provided for the large rotary knob, the small rotary knob and/or the push function of the small rotary knob.

A feature may be provided that allows for inhibiting particular rotary list selection items based on the context of the avionic system at the time the softkey button is actuated. In the illustrative embodiment, these list items are “grayed out” and cannot be selected by the control. This allows a design that prevents access to functionality when the functionality is not possible or should be prevented, such as for safety reasons.

These and other objects, advantages and features of this invention will become apparent upon review of the following specification in conjunction with the drawings.

### BRIEF DESCRIPTION OF THE DRAWINGS

FIG. 1 is an elevation of a pilot user interface, according to the invention;

FIG. 2 is a diagram representing a dual concentric knob;

FIG. 3 is a diagram illustrating an example of user interface architecture;

FIG. 4 is a diagram illustrating split parameter editing;

FIG. 5 is a diagram illustrating editing of alphanumeric parameters;

FIG. 6 is a diagram illustrating context sensitive labeling of a dual concentric knob;

FIG. 7 is a chart illustrating examples of parameter edit functions that may be performed by a context sensitive dual concentric knob;

FIG. 8 is a screen display of a pop-up menu selection list;

FIG. 9 is an illustration of context sensitive buttons, or softkeys;

FIG. 10 is a screen display of a softkey rotary selection list;

FIGS. 11a and 11b are screen displays of an alternative soft key rotary selection list;

FIGS. 12a-12g are a series of screen displays illustrating an alphanumeric editing function in which an airport identification is sequentially changed from KAAA to KCMH;

FIGS. 13a-c are diagrams illustrating examples of context sensitive labeling of a dual concentric knob;

FIGS. 14a-d are charts illustrating examples of context sensitive labels that may be applied to one or more dual concentric knobs; and

FIGS. 15a-c are screen displays of another alternative soft key rotary selection list.

### DESCRIPTION OF THE PREFERRED EMBODIMENT

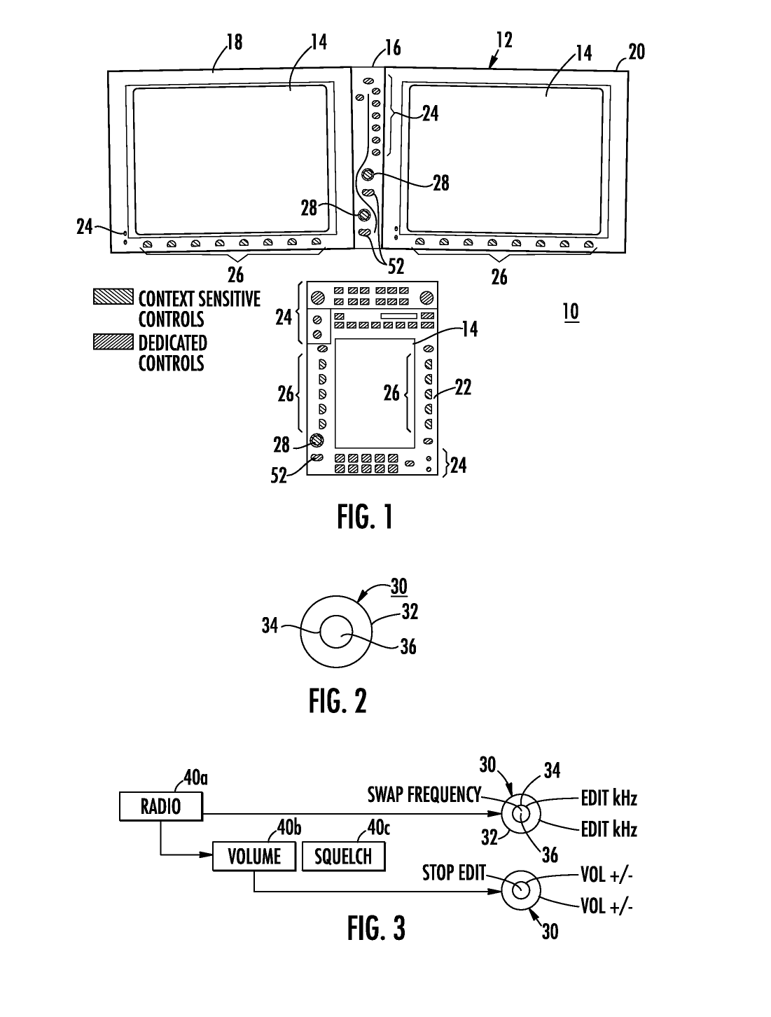

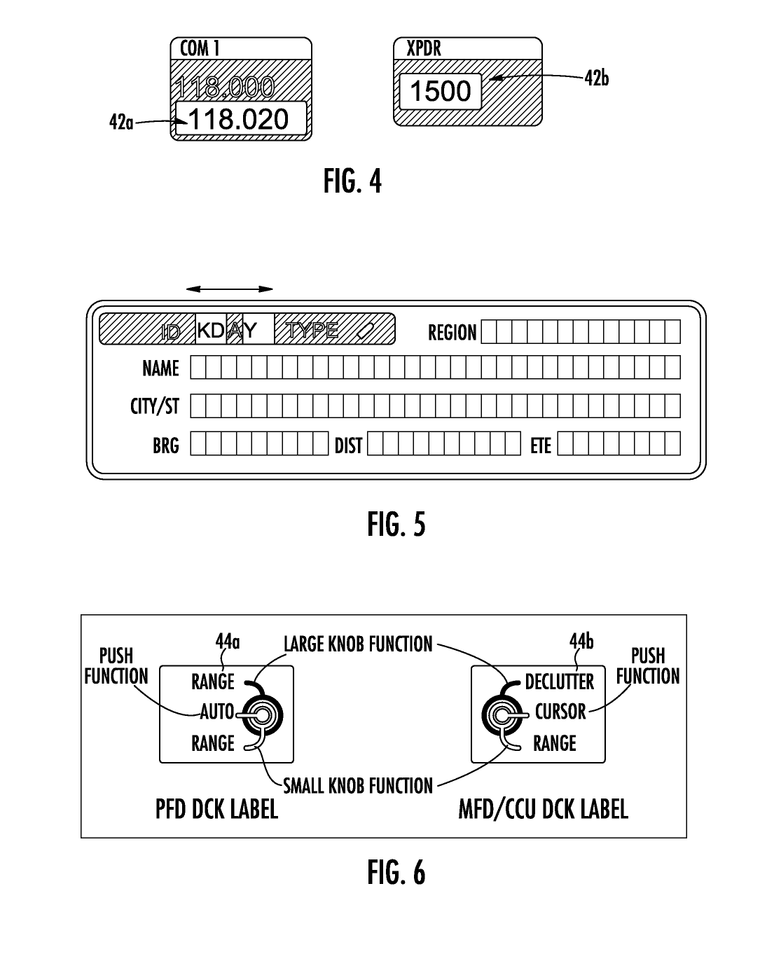

Referring now specifically to the drawings, and the illustrative embodiments depicted therein, an aircraft avionics system 10 includes a pilot interface 12 (FIG. 1). The pilot user interface includes one or more display screens 14 and one or more video processors (not shown) driving the display screen(s). It should be understood that the term video processor is not intended to be limited to any particular electronic hardware or software configuration. In the illustrative embodiment, the display screens are solid-state displays, such as liquid crystal displays, plasma displays, or the like. However, the invention is useful with other forms of electronic displays, such a cathode ray tubes, and the like.

In the illustrative embodiment, the pilot user interface is made up of a flight display controller 16 that controls the behavior of the primary flight display (PFD) 18, a multifunctional display (MFD) 20, or both. The pilot user interface may further include a center control unit (CCU) 22. Multifunctional display 20 may also function as a reversionary flight display upon failure of either the primary flight display 18 or the center control unit 22.

Pilot interface 12 includes one or more dedicated buttons 24. Dedicated buttons have a permanently affixed label on the surface of the button that indicates the function that the buttons will perform when pressed or otherwise actuated. Examples of functions performed by dedicated buttons include activation of the reversionary display page on both the primary flight display 18 and multifunctional display 20, display of crew alert and warning system (CAWS) messages, radio controls, map controls, and the like.

Pilot user interface 12 additionally includes one or more context sensitive buttons 26, which are also referred to as softkeys. Context sensitive buttons 26 provide programmable functionality for each display format based on the selected function, as will be described in more detail below. Pilot user interface 12 may further include one or more context sensitive knobs 28. Context sensitive knobs 28 include context-related functional labels on the display screen adjacent to the knob, as will be described in more detail below.

In the illustrative embodiment, context sensitive knobs 28 include one or more dual concentric knobs 30. A dual concentric knob 30 includes a large rotary knob 32, a small rotary knob 34 and a push button function 36 that is carried out by pressing small rotary knob 34 in the direction of its axis of rotation. One function of large rotary knob 32 is to move a selected highlight between different fields or items on a display, as will be described in more detail below. Thus, the large rotary knob can be used to scroll list items and character sequences. As will also be disclosed in more detail below, the large rotary knob may be used to edit the most significant digits of a numeric parameter on a split parameter edit. An example would be to edit the MHz portion of a radio frequency. Small rotary knob 34 may be used to edit alphanumeric characters and numeric parameters. It may also be used to edit the least significant digits of a numeric parameter when used in combination with the large rotary knob 32. An example is to edit the kHz portion of a radio frequency. Push button function 36 may be used to take a single context sensitive action related to the functionality group being performed. For example, the push button function may be used to synchronize values, swap frequency fields, transponder identification, activation of the map cursor and accepting entries from lists and certain edits.

An example of the interfaced architecture of pilot user interface 12 is illustrated in FIG. 3. A function of a dedicated button 24, which is typically at the top level of the architecture, is to change the display page format. The new page format is supported by graphically updated context sensitive controls. At the next level, the context sensitive buttons will bring up lower level functions and/or change the functionality access. This helps to keep the interface shallow and to minimize the number of button presses and pilot actions that must be performed to get to a specific function. In the example illustrated in FIG. 3, a radio function 40a represents a dedicated button 24. Once the dedicated radio button is pressed, the dual concentric knob 30 changes functionality to perform editing and swapping of frequencies. At the same time, context sensitive buttons 26 allow access to volume 40b and auto-squelch functions 40c. Then, when the volume context sensitive button is pressed, the label and functionality of dual concentric knob 30 is changed to allow editing of the radio volume. Once that operation is complete, the prior functionality of editing and swapping of frequencies is restored.

Operation of split parameter editing is illustrated with respect to FIG. 4. In split editing with decimal 42a, the large and small rotary knobs 32, 34 edit a separate part of the parameter. In split parameter editing with decimal 42a, the large rotary knob 32 is used to edit values to the left of the decimal point. The small rotary knob 34 edits values to the right. In split editing without decimal 42b, the large rotary knob 32 is used to edit the left half values, or most significant digits, and the small rotary knob 34 edits the right values of the parameter, or the least significant digits.

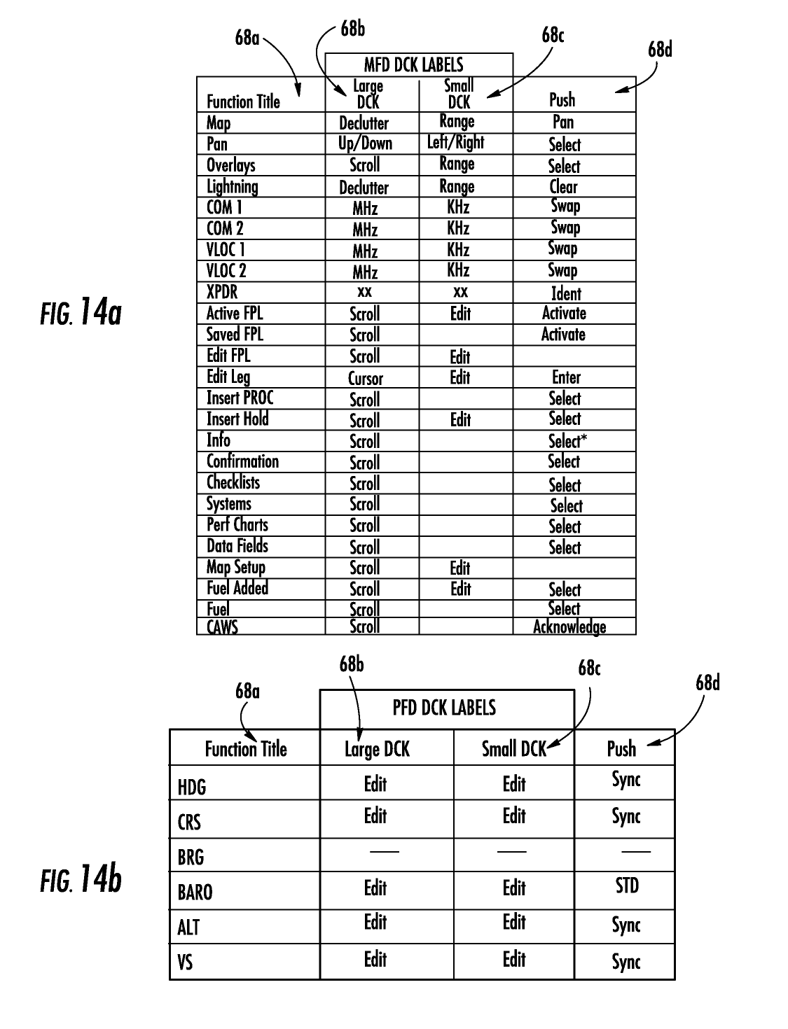

One example of the editing of alphanumeric parameters is illustrated with respect to FIG. 5. The large rotary knob 32 may be used to move the highlighting left and right as illustrated by the arrow in FIG. 5. Small rotary knob 34 may be used to change the value of each highlighted character. Another example of the editing of alphanumeric parameters is illustrated in FIGS. 12a-g. FIGS. 12a-g illustrate an image 38 that includes information relating to an airport, such as the type of airport, the identification of the airport (ID), the name of the airport, the name of the city associated with the airport, the bearing to the airport (BRG), the distance to the airport, and the estimated time en-route (ETE). Image 38 may be displayed on all of, or a portion of, any one or more of display screens 14 of primary flight display 18, multi-multifunctional display 20, center control unit 22, or any other device within the cockpit of the aircraft that includes a display. The information contained within image 38 can, of course, be varied to contain information different from the airport information that is illustrated in FIGS. 12a-g. However, the following detailed explanation of one illustrative manner of editing alphanumeric characters in image 38 will be described with respect to airport information. Those skilled in the art will recognize that this manner of editing can be applied to information besides airport information.

FIGS. 12a-e illustrate an alphanumeric field 64 containing four characters that identify a particular airport. In the example of FIG. 12a, the letters are KAAA, which identify the Logan Co. airport in Lincoln. Ill. The characters within alphanumeric field 64 may be changed via a dual concentric knob 30 associated with the particular display screen 14 on which image 38 is being displayed. The location of the associated dual concentric knob 30 may be varied, but generally would be within the vicinity of image 38, and therefore may be dependent upon which of the displays 14 image 38 is being displayed upon. Manipulation of the large and small rotary knobs 32 and 34 of the dual concentric knob 30, along with pushing of button 36, causes changes to be made to the characters within field 64 in a manner that will now be described.

As shown in FIG. 12a, a cursor 66 begins by default in a left-most position within field 64. An associated dual concentric knob 30 is used to edit the information within field 64. In the example illustrated in the series of drawings depicted in FIGS. 12a-12g, the airport ID is edited from KAAA to KCMH. Because both of these airport IDs share the first same letter, no editing needs to be performed to the letter “K.” Accordingly, a pilot wishing to change the KAAA airport ID in FIG. 12a to KCMH would leave the “K” unchanged. In order to accomplish that, the pilot would, in one embodiment, rotate the large rotary knob 32 of the associated dual concentric knob 30 clockwise one click to move cursor 66 to the right one position within field 64. This would move cursor 66 to the position illustrated in FIG. 12b.

To edit the left-most “A” in FIG. 12b, the pilot rotates the small rotary knob 34 clockwise to increase the alphabetic value of the character at the current cursor position. Such clockwise rotation continues until the letter “C” appears in the second left-most position within field 64. As can be seen in FIG. 12c the changing of the letter “A” in FIG. 12b to “C” in FIG. 12c, causes the airport ID to change from KAAA to KCAD. The reason why the right-most “A” changed to a “D” in the embodiment illustrated in FIG. 12c is that the avionics system 10 includes a database of valid airport IDs and system 10 is adapted to include an auto-complete feature in which characters to the right of cursor 66 are automatically completed, or filled in, based upon the information within the database. More specifically, when configured with the auto-complete feature, system 10 will automatically fill in the characters to the right of the cursor 66 with the airport ID letters from the alphabetically first airport ID within the database that shares the same initial ID letter or letters to the left of, and including, the position of cursor 66. From FIG. 12c, it can therefore be seen that the database avionics system 10 has access to does not include any airport IDs corresponding to KCAA, KCAB, or KCAC. The alphabetically first airport ID within the database that has the letters “KC” in the left-most positions of the airport ID field 64 is airport ID KCAD, which is shown in FIG. 12c. Avionics system 10 can, of course, be modified such that no auto-complete feature is used with the editing of aircraft IDs, if desired.

As can also be seen in FIG. 12c, the airport information displayed within image 38 is automatically updated to include the information that corresponds to the airport currently identified within alphanumeric field 64. Thus, the aircraft ID “KCAD” illustrated in FIG. 12c corresponds to an airport named Wexford Co, which is associated with the city of Cadillac, Mich., and has the bearing and distance information shown in FIG. 12c.

To edit the third character within alphanumeric field 64, a pilot rotates clockwise the large rotary knob 32 of the dual concentric knob 30 associated with the display 14, or other display, on which image 38 is being displayed. This causes cursor 66 to move one position to the right within alphanumeric field 64. Rotation of the large rotary knob 32 counterclockwise causes cursor 66 to move one or more positions to the left within field 64. FIG. 12d illustrates the effect of rotating rotary knob 32 clockwise such that cursor 66 shifts one position to the right within field 64 from the position cursor 66 occupied in FIG. 12c.

To change the third character within field 64 from an “A” to an “M”, the pilot rotates the small rotary knob 34 clockwise until an “M” is displayed in the third position, such as is illustrated in FIG. 12e. As is further illustrated in FIG. 12e, the changing of the third character to an “M” causes the fourth character to revert back to an “A,” due to the auto-complete feature. In other words, the airport having the ID “KCMA” is the first airport in the alphabetical database of airports having the letters “KCM” in the left-most three positions. FIG. 12e also illustrates that the information displayed within image 38 is also automatically updated to correspond to the airport having the “KCMA” identification.

To edit the right-most character within field 64, the pilot rotates the large rotary knob 32 clockwise, causing cursor 66 to shift to the right, such as is shown in FIG. 12f. Editing of the right-most character within field 64 is performed in the same manner as has been described. That is, clockwise rotation of the small rotary knob 34 of the associated dual concentric knob 30 causes the letters to change in alphabetical order. Rotation in the counterclockwise direction causes the letters to change in reverse alphabetical order. Small rotary knob 34 can thus be rotated until the desired letter is reached, which, in the illustrated embodiment, is the letter “H”, as shown in FIG. 12g. After the desired editing of the characters within field 64 is completed, a pilot may press push button 36 to accept the entered text. Dual concentric knobs 30 may be used for editing text or numbers, and for other purposes, besides the examples illustrated in FIGS. 12a-12g, and such other context sensitive uses will be apparent to the skilled artisan.

Labeling of dual concentric knobs 30 is illustrated with respect to FIG. 6. A label display 44a, 44b may be a transparent background-three-legged graphic that points to the small and large rotary knobs 32, 34 and the push button function 36 and support labels that correspond to the identity of each of the functions available. Each of the three-legged graphic labels are context dependent labels. Label 44a is used for displays that are positioned to the left of the dual concentric knob. Display 44b is used for dual concentric knobs to the left of the display. The label display may be a dedicated display or may be displayed on a portion of the corresponding display screen 14 that is adjacent to the respective dual concentric knob. Where only a portion of the dual concentric knob has functionality, the portions of the dual concentric knob that have functions are labeled with text. The other portions are left blank. The processor may be adapted to separately highlight each of the graphic labels of either three-legged graphic 44a or 44b. The highlighted context dependent label identifies which of the knobs 32, 34 or push button 36 have active functions associated with corresponding controls.

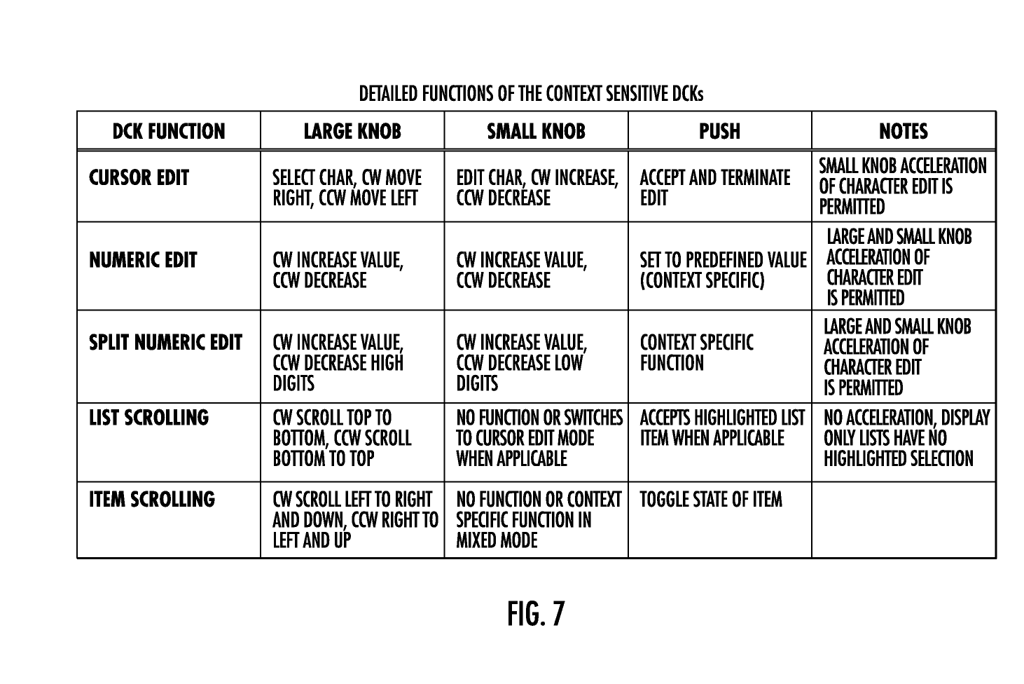

Examples of parameters that can be edited with a dual concentric knob 30 are illustrated in FIG. 7. It should be understood that this list is by way of example and is not intended to be exhaustive. Reference in the list to an acceleration function is in reference to editing speed. When a large or small rotary knob is rotated at a rate below a particular time threshold established for that parameter, the parameter is increased or decreased by a minimum increment established for the parameter being edited. This is referred to as normal-speed editing. When a knob is rotated at a speed at or above the particular time threshold established for that parameter, the parameter is increased or decreased by the maximum increment established for the parameter being edited. This is referred to as accelerated speed editing.

Several examples of an alternative dual concentric label display 44′ are illustrated in FIGS. 13a-c. Dual concentric label displays 44′ may be displayed on a dedicated display, or they may be displayed on a portion of one or more of display screens 14, such as, for example, PFD 18, MFD 20, center control unit (CCU) 22, or some other device having a display screen. The dual concentric knob 30 to which the label 44′ applies may be positioned to the right, to the left, above, or below the label 44′. Each dual concentric label display 44′ includes a plurality of label fields 68 in which context-sensitive labels may be inserted.

In the illustrations of FIGS. 13a-c, label displays 44′ include a dual concentric knob (DCK) function title field 68a, a large knob function field 68b, a small knob function field 68c, and a push button function field 68d. DCK function title field 68a identifies the function that the associated dual concentric knob 30 is currently controlling. For example, in the illustration of FIG. 13a, DCK function title field 68a includes the label “COM 1,” which refers to a first communications channel. Thus, the video processor(s) of aircraft avionics system 10 cause label display 44′ to appear in a position near the associated dual concentric knob 30, such as on one of display screens 14, when dual concentric knob 30 is providing the function of changing values associated with the first communications channel.

Label fields 68b-d identify the specific parameters that may be edited with the large knob 32, small knob 34, and push button 36 of the associated dual concentric knob 30, respectively. In the example illustrated in FIG. 13a, large knob function field 68b includes the label “MHz”. Thus, rotation of the large knob 32 in the context illustrated in FIG. 13a effects a change in a radio frequency megahertz (MHz) value. Rotation of the small knob 34 in the context illustrated in FIG. 13a effects a change in a radio frequency kilohertz (KHz) value. Pushing of push button 36 in the context illustrated in FIG. 13a causes a swapping of values, such as, but not limited to, the swapping of communication frequencies between COM 1 and COM2.

FIG. 13b illustrates another example of a label display 44′ in which label fields 68a-d include labels that are different from those illustrated in FIG. 13a. In the example of FIG. 13b, DCK function title label 68a includes the label “MAP,” which indicates that the associated dual concentric knob 30 is, at the moment label display 44′ of FIG. 13b is active, available for controlling various map functions. More specifically, as is shown in 13b, large knob function field 68b includes the lable “Declutter,” which indicates that any adjustments of large knob 32 of the associated dual concentric knob 30 will effect a decluttering of the map view currently being displayed on one or more of display screens 14. Small knob function field 34 includes the label “Range,” which indicates that any adjustment of small knob 34 will effect adjustments to the range of the map view currently being displayed on one or more of display screens 14. Push button function field 68d includes the label “Pan,” which indicates that pushing push button 36 will effect a panning of the map view currently being displayed on one or more of display screens 14.

As can be seen in FIG. 13c, label display 44′ may be blank. In such instances, function label fields 68a-d do not include any text or characters. Such instances may occur at various times depending upon the context of the information that is being displayed on one or more display screens 14, and/or the functions that have been selected. When no information is included in label fields 68a-d, the associated dual concentric knob 30 does not perform any function, and rotation of either large knob 32 or small knob 34, as well as pushing of button 36, has no effect on the content of information displayed on screens 14, or any of the functions currently being performed by avionics system 10.

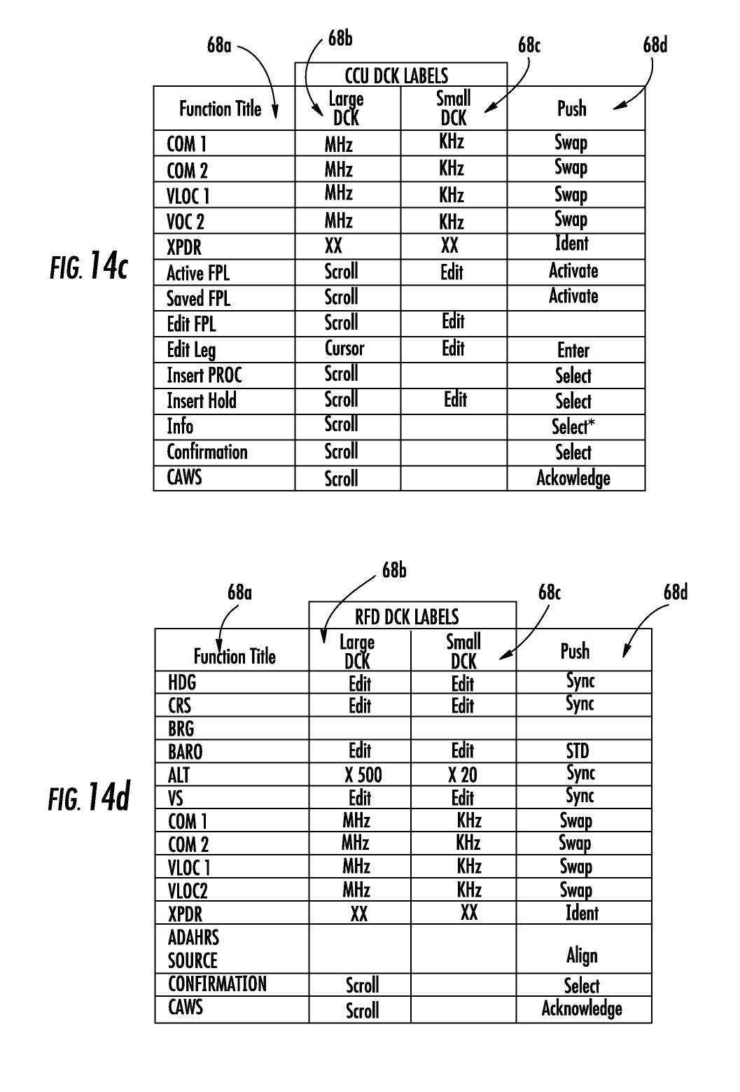

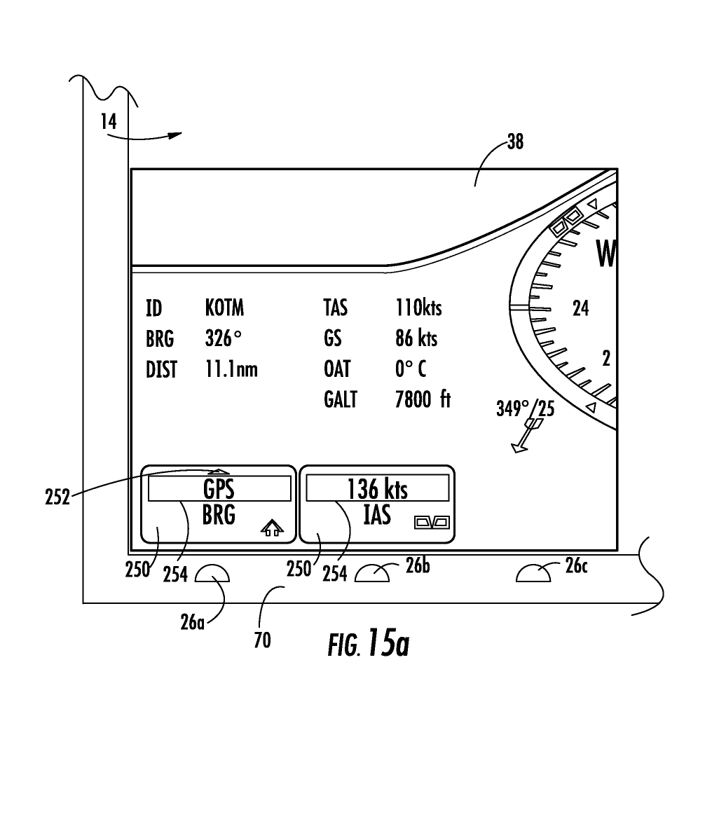

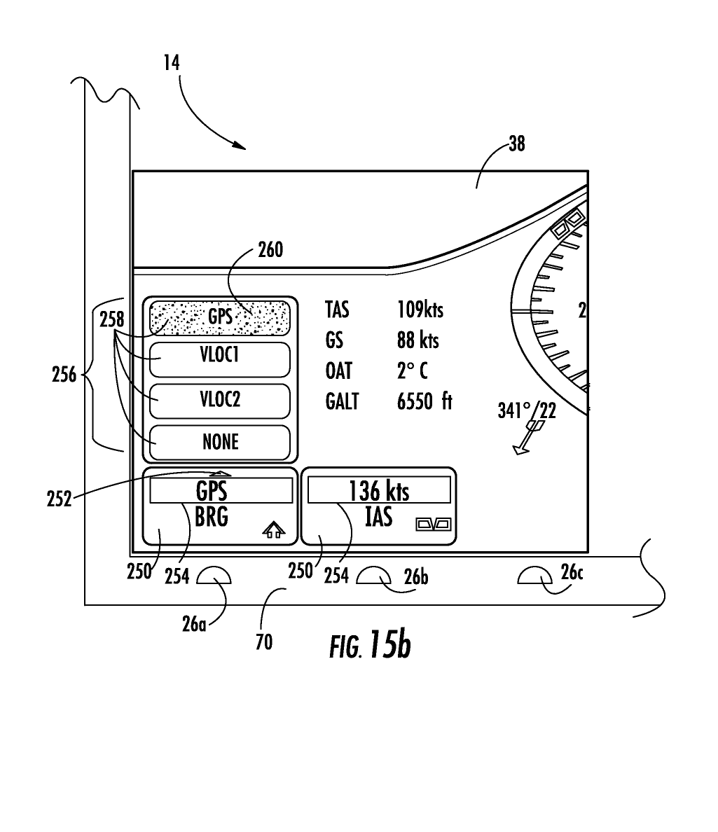

FIGS. 13a-b illustrate only a sampling of the various labels that may be applied in label fields 68a-d of label display 44′. The charts of FIGS. 14a-d identify additional labels that may be applied to label fields 68a-d. FIG. 14a identifies additional labels that may be used with a dual concentric knob 30 that is associated with a multifunction display (MFD) 20. That is, the labels illustrated in FIG. 14a identify functions that are particularly appropriate or common for use with a MFD, such as MFD 20. FIG. 14b identifies labels that may be used with a dual concentric knob 30 that is associated with a primary flight display (PFD) 18. In one embodiment, the dual concentric knob 30 that may be associated with the labels of FIG. 13a is the same as the dual concentric knob 30 that may be associated with the labels of FIG. 13b. In another embodiment, the dual concentric knob that may be associated with the labels of FIG. 13a is different from the dual concentric knob 30 that may be associated with the labels of FIG. 13b.

FIG. 14c identifies additional labels that may be used with a dual concentric knob 30 that is associated with a center control unit (CCU), such as CCU 22. FIG. 14d identifies additional labels that may be used with a dual concentric knob 30 that is associated with a radio function display (RFD), which may be an additional component of avionics system 10. In each of the charts of FIGS. 14a-d, there are four columns. The first column identifies the various labels that may be applied to DCK function title field 68a. The second column identifies the various labels that may be applied to large rotary knob field 68b. The third column identifies the various labels that may be applied to small rotary knob field 68c. The fourth column identifies the various labels that may be applied to push button function field 68d. It will be understood, of course, that the labels illustrated in FIGS. 14a-d are only representative of the types and kinds of labels that may be displayed on label display 44′ (or label display 44), and that a given avionics system 10 may use only a subset of these labels, may use additional labels, or may use different labels. Further, the functions associated with the various labels illustrated in FIGS. 14a-d would be apparent to one skilled in the art, and therefore they do not need to be described individually.

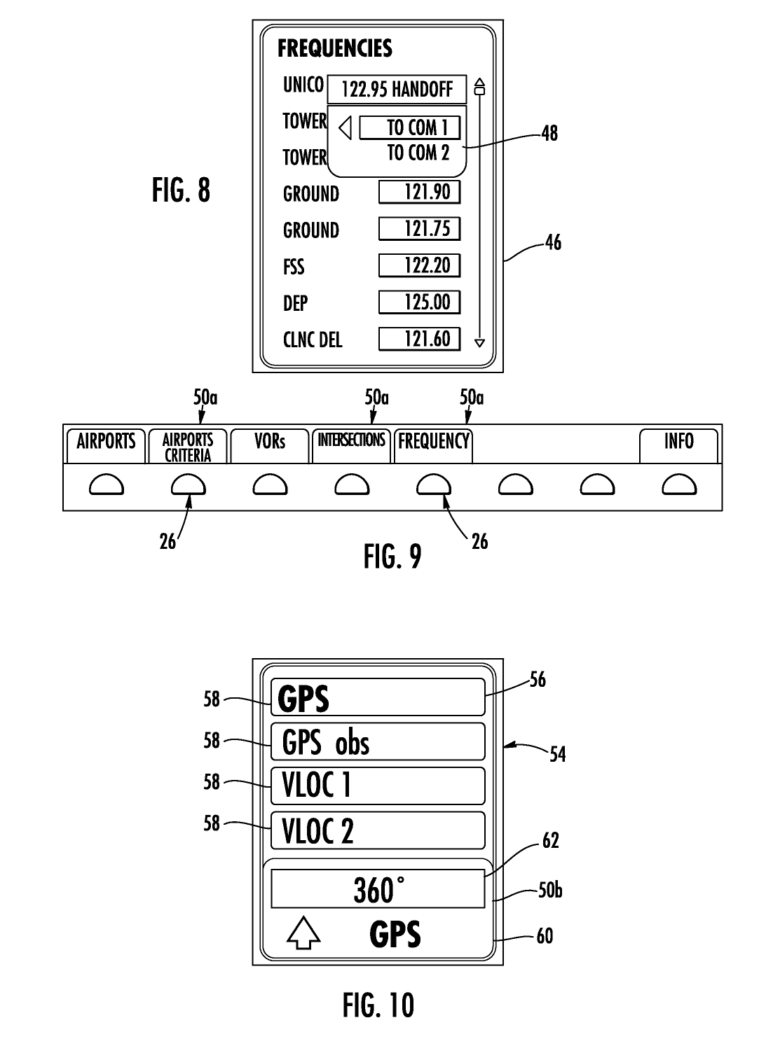

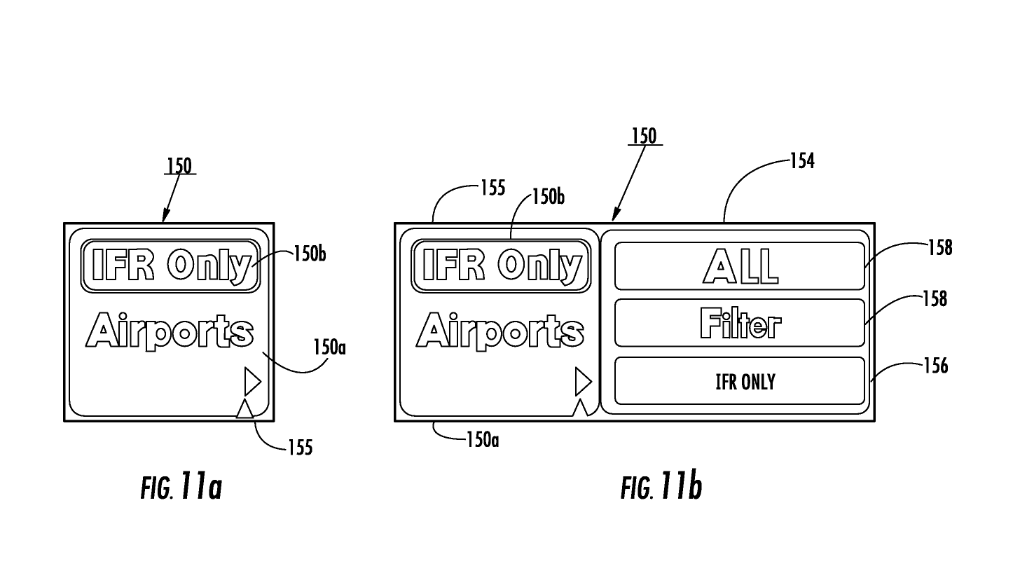

A pop-up list 46 may be used in combination with a dual concentric knob 30 (FIG. 8). Normally, the popup list is hidden until a user interface action occurs that causes the list to display. Once the pop-up list is displayed, a portion 48 is highlighted. The pilot may scroll the highlighted portion through the various parameters, such as by rotating the large rotary knob 32.

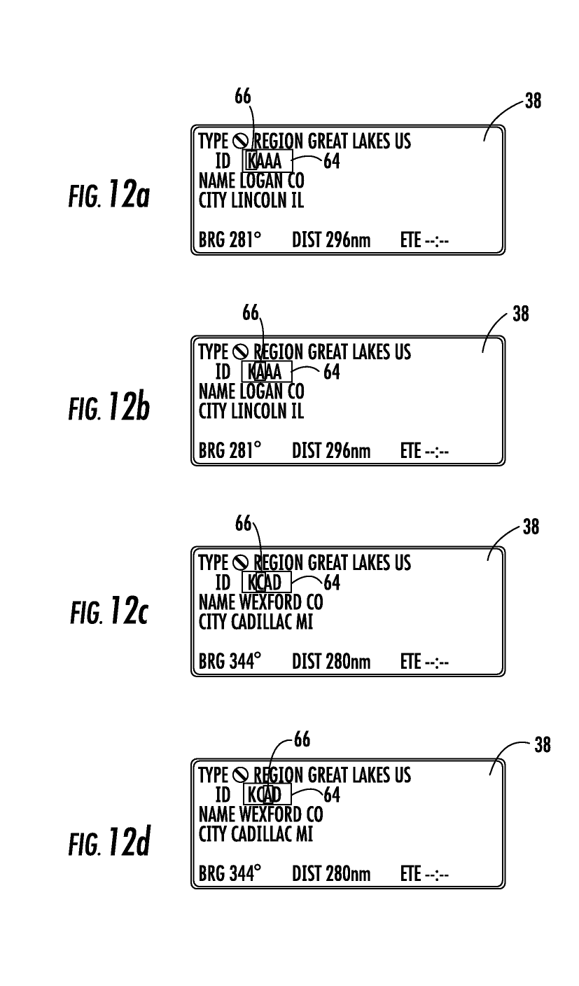

As previously set forth, pilot user interface 12 includes bush button controls that are categorized into “dedicated” and “context sensitive” buttons. Dedicated buttons with permanent labels are also referred to as hard keys and generally perform the same function. Dedicated buttons can be made context sensitive through an associated rotary list menu. In particular, a particular hard key selectable category of a rotary list menu may take the user interface to displays related to the category selected. Context sensitive buttons 26 perform different functions based upon the current display format and/or function to be performed. Context sensitive buttons 26 have labels 50a, 50b that are rendered on display screen 14 adjacent to each button having a function (FIG. 9). Context sensitive buttons may also be referred to as softkeys. Some buttons with permanent labels may be hybrid buttons having a context sensitive operation. For example, the function of a back button 52 located under a context sensitive knob 28 depends upon what function is being performed (FIG. 1). When editing, the back button 52 may cancel the edit. When not editing, the back button 52 may return the user interface to a higher level. In addition, it is possible that a single function may be accessed from the two different areas within the user interface. When this occurs, back button 52 will return to the location of the user interface from which the function was accessed. The back-up button may also be used to back up steps, such as one step per press of the button, in a sequence of operations. Labels may be static labels 50a or dynamic labels 50b (FIG. 9). A context sensitive button 26 may be statically labeled using one or two lines of text that never changes when the softkey label is displayed as illustrated in FIG. 9. A label may, alternatively, be a dynamic label 50b that is used when the entire label needs to change to indicated multiple related selections. An example of a dynamic softkey label 50b is illustrated with respect to FIG. 10.

FIG. 10 illustrates a softkey rotary selection list 54. Rotary softkey selection list 54 is associated with a softkey dynamic label 50b. Rotary selection list 54 is displayed upon press of the softkey with which the list is associated. The first press of the softkey only displays the list. One item is highlighted as illustrated at 56. Subsequent presses of the corresponding softkey 26 move highlighted area 56 from one item 58 to another item 58. As each item is selected, an associated change in the system takes place. Text field 60 of dynamic softkey label 50b changes with the selection of item 58 by highlight 56. Dynamic label 50b may additionally include a parameter field 62 to display the parameter associated with text field 60, which, as previously set forth, is the highlighted item 56 from the rotary selection list. Particular rotary list selection items may be inhibited based upon the context of the avionic system at the time the softkey button is activated. These “grayed out” list items cannot be selected by the control. This allows a product design that prevents access to functionality when the functionality is not possible or should be prevented, such as for softkey reasons.

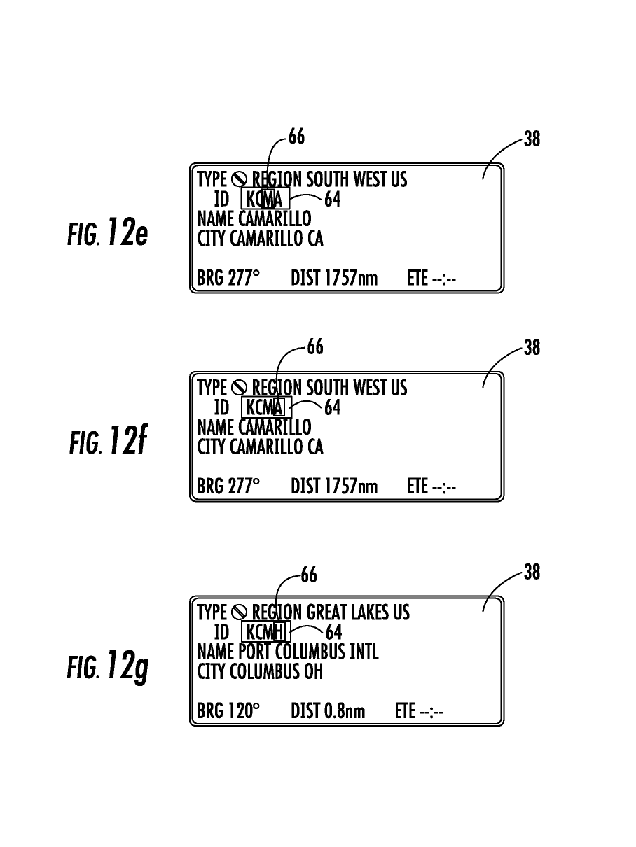

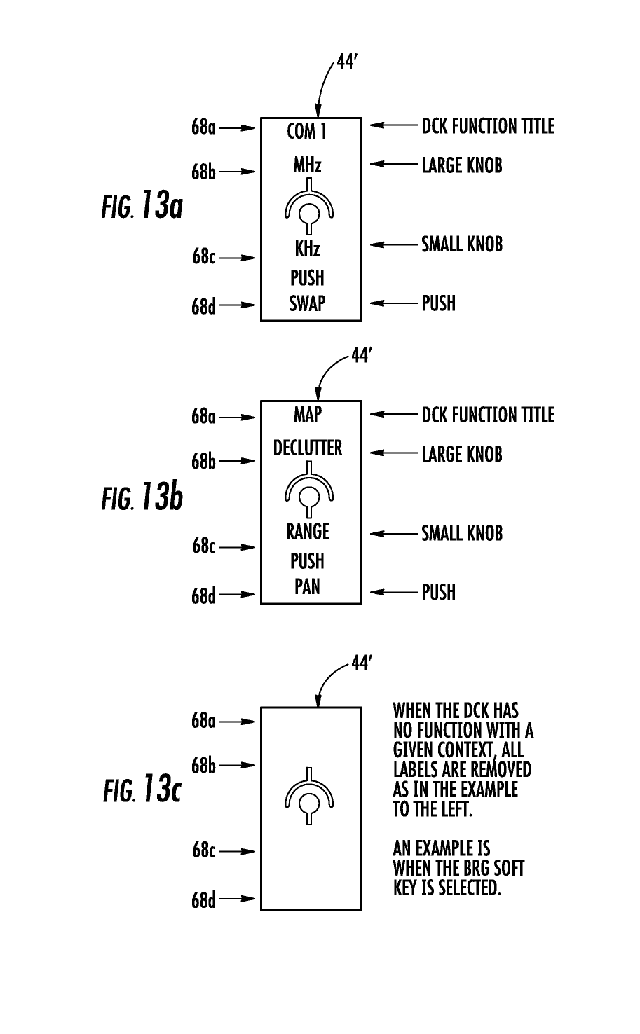

An alternative soft key rotary selection list 150 includes a soft key 155 which has a soft key label 150a of the functions the rotary list is associated with and a window 150b that contains the current selection from the rotary list (FIG. 11a). Upon first press of soft key 155, a rotary list 154 is displayed (FIG. 11b). Rotary list 154 includes possible selections 158. Subsequent presses of soft key 155 cycles the highlighted area 156, such as from top to bottom and then wrapped back to the top. After an interval of time, such as 3 seconds, for example, the rotary list will be removed from the display. The selected item will appear in the soft key window 150b and the selection will become active.

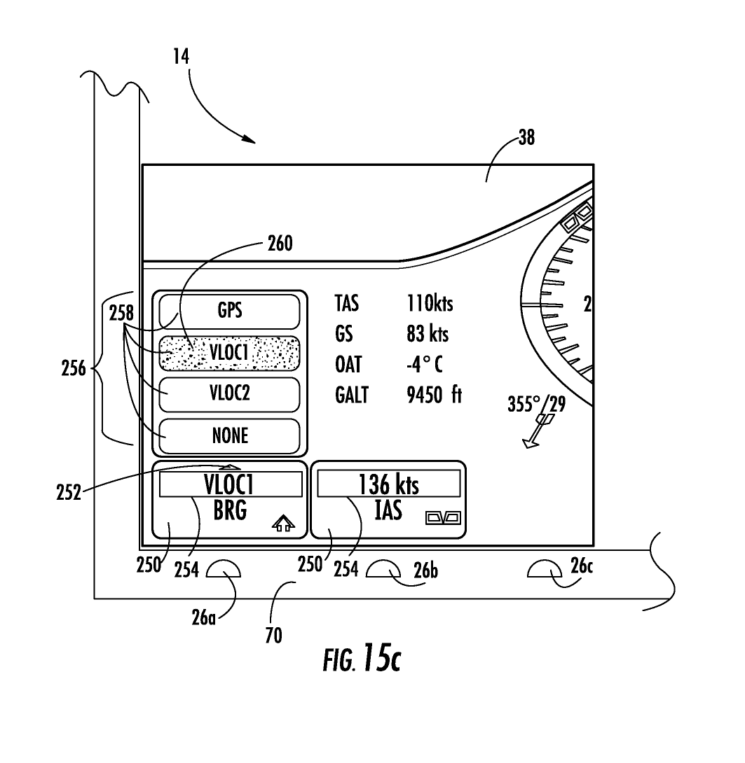

Another alternative manner of implementing a soft key rotary selection list is illustrated in FIGS. 15a-c. FIGS. 15a-c illustrate a portion of an image 38 that may be displayed on any of display screens 14. FIGS. 15a-c further illustrate a portion of a corresponding frame or perimeter 70 that surrounds display screen 14 and on which one or more context sensitive push buttons 26 may be positioned, three of which are shown in FIGS. 15a-c. Located on display screen 14 above context sensitive buttons 26a and 26b are soft key labels 250. The soft key label 250 above context sensitive button 26a includes the letters “BRG,” which are an abbreviation for bearing. The soft key label 250 above context sensitive button 26 includes the letters “IAS,” which are an abbreviation for indicated air speed.

The soft key label 250 with the letters “BRG” further includes an upward arrow 252. Upward arrow 252 indicates that a rotary selection list 254 (FIGS. 15b-c) is associated with that particular soft key label 250. As can be seen, the soft key label 250 positioned above context sensitive button 26b does not include an upward arrow 252, and accordingly there is no rotary selection list associated with soft key 26b in the particular context shown in FIGS. 15a-c. Arrow 252 thus provides a visual indication to the pilot as to what soft key labels 250 do and do not have rotary lists associated with them.

Each soft key label 250 may further include a window 254. In the embodiments shown, window 254 is positioned vertically above the characters within soft key labels 250, although it will be understood that the position of window 254 can be varied from that shown. Window 254 indicates information about the particular soft key label 250 with which it is associated. For example, window 254 above soft key 26a indicates that the current source of bearing information is coming from a GPS system. Further, window 254 above soft key 26b indicates that the current indicated airspeed is 136 knots.

Pressing of soft key 26a will cause the video processor(s) of avionics system 10 to display a rotary selection list 256 (FIGS. 15b-c). The particular rotary selection list of FIGS. 15b-c include four selections 258, which are labeled “GPS,” “VLOC1,” “VLOC2,” and “NONE.” The top-most selection 258 in FIG. 15b includes a highlighted area 260, which may be implemented in a variety of different manners, such as by changing the color of the text within selection 258, by changing the color of the background surrounding the text, by changing the font, or font size, or by other means. The highlighted area 260 identifies the selection 258 that has been currently selected for implementation and display within window 254. By pressing soft key 26a an additional time, highlighted area 260 will move down one selection within rotary list 256, such as is illustrated in FIG. 15c, where highlighted area 260 has moved to the selection 258 labeled “VLOC1.”

Further pressing of soft key 26a will cause the highlighted area 260 to continue to move down rotary list 256 until it reaches the selection 258 at the bottom of the list. Thereafter, continued pressing of soft key 26a will return the highlighted area 260 to the top of rotary selection list 256 and continue to move the highlighted area down one selection 258 per pressing of the button 26a. In this manner, a pilot can select the appropriate selection 258 by pressing soft key 26a as many times as necessary to highlight the desired selection 258. If the pilot proceeds too far, he or she can return to the desired selection 258 by continuing to press soft key 26a until the highlighted area 260 cycles through the rotary list and back to the desired selection 258.

In the example illustrated in FIGS. 15a-c, rotary list 256 provides a list for selecting the source of bearing information. By choosing from the selections 258 within list 256, a pilot can choose the source for the bearing information displayed to the pilot. The bearing information may be displayed on image 38, or any other suitable location. As with the rotary selection process illustrated in FIGS. 11a-b, rotary selection list 256 will automatically disappear from screen 14, or whatever screen it is displayed on, after a set amount of time passes without any further pressing of the associated soft key (e.g. soft key 26a in the illustrated example).

While FIGS. 15a-c illustrate the use of a rotary selection list 254 in conjunction with a context sensitive key (soft key 26a), it will be understood that rotary selection list 256 could be implement using a touch screen, in which case a pilot would bring up list 256 by directly pressing on the portion of the display screen 14 on which soft key label 250 is displayed. Further touching of that area of display screen 14 would cause the highlighted area 260 to cycle through the different selections 258 to enable the pilot to choose the desired selection 258.

As yet another alternative, it will be understood that the position of rotary display list 256 may be varied from that shown in FIGS. 15a-c, depending upon the position of the associated context sensitive key in relation to the display screen 14, or other factors. For example, FIGS. 15a-c illustrate soft keys 26a-c positioned underneath display screen 14, but the position of soft keys 26a-c, or some other type of context sensitive control, could be varied from that illustrated. For example, if the associated context sensitive control were positioned to the left of the associated soft key label 250, rotary list 256 could be adapted to appear to the right of soft key label 250, such is illustrated in FIG. 11b. If the associated context sensitive control were positioned to the right of the associated soft key label 250, rotary list 256 could be adapted to appear to the left of the soft key label 250. Similarly, if the associated context sensitive control were positioned above the associated soft key label 250, rotary list 256 could be adapted to appear below the soft key label. Other variations are also possible. The direction in which arrow 252 points could also be varied such that it points toward the area on display screen 14 in which the associated rotary list 256 will be displayed when the context sensitive control is activated. Other manners of indicating that a rotary list is associated with a particular soft key label 250 besides arrows can, or course, be utilized.

An advantage of the rotary selection list is that it allows the pilot to view all of the selections available with the rotary selection list. This provides more information to the pilot without adding additional layers to the architecture. Thus, pressing of a context sensitive button 26 associated with a rotary selection list 54, 154, or 256, causes the list to popup out of the label associated with the button and display the items available for selection. Then, by repeated pressing of the softkey 26, the highlighted item cycles through the various selections that are available. This displays to the pilot the available states without changing the context of the display. Also, the softkey label may be able to display the current selection of the rotary list, or a related status, without having to press the softkey button.

Changes and modifications in the specifically described embodiments can be carried out without departing from the principles of the invention. For example, although various input devices are illustrated as hardware push buttons and rotary knobs, they may be performed by other mechanisms, such as touch screens, locating devices, and the like. Also, soft keys having rotary lists associated with them may be identified as such. The invention is intended to be limited only by the scope of the appended claims, as interpreted according to the principles of patent law including the doctrine of equivalents.

The embodiments of the invention in which an exclusive property or privilege is claimed are defined as follows:

1. An aircraft avionic system having a pilot user interface, said system comprising:
a display screen;
a video processor driving said display screen; and
a plurality of context dependent input devices, wherein operation of one of said input devices causes said processor to display a rotary selection list on said display screen, said rotary selection list including a menu of selectable options, each capable of effecting a change in said avionic system when highlighted and wherein subsequent operation of said one of said input devices causes a different one of said selectable options to be highlighted.

2. The system as claimed in claim 1 wherein said input devices comprise at least one selected from push buttons and a touch screen.

3. The system as claimed in claim 1 or claim 2 wherein said processor is adapted to drive said display screen to display a parameter associated with the highlighted one of said selections.

4. The system as claimed in claim 3 wherein at least one of said input devices comprising at least one rotary knob, said processor adapted to drive said display screen to display a context dependent label for said at least one rotary knob and wherein rotation of said at least one rotary knob edits at least a portion of said parameter.

5. The system as claimed in any of the preceding claims wherein said rotary selection menu remains hidden until operation of said one of said input devices.

6. The system as claimed in claim 5 wherein said rotary selection list becomes displayed upon actuation of said one of said input devices with one of said options highlighted.

7. The system as claimed in any of the preceding claims wherein said one of said input devices comprises a soft key.

8. The system as claimed in any of the preceding claims wherein said rotary selection list includes at least one inhibited option that is inhibited from effecting a change in said avionic system under particular context of said aircraft avionic system.

9. An aircraft avionic system having a pilot user interface, said system comprising:
a display screen;
a video processor driving said display screen; and
a plurality of context dependent input devices, at least one of said input devices comprising at least one rotary knob, said processor adapted to drive said display screen to display a context dependent label for said at least one rotary knob and said processor adapted to drive said display screen to display a parameter of said avionic system, wherein rotation of said at least one rotary knob edits at least a portion of said parameter.

10. The system as claimed in claim 9 wherein said at least one rotary knob comprises a large rotary knob and a small rotary knob that is smaller than and concentric with said large rotary knob.

11. The system as claimed in claim 10 wherein rotation of said large rotary knob edits a most significant portion of said parameter and rotation of said small rotary knob edits a least significant portion of said parameter.

12. The system as claimed in claim 10 or claim 11 wherein said processor is adapted to drive said display to display a plurality of parameters of said avionic system and wherein rotation of said large rotary knob causes said processor to drive said display to highlight different ones of said parameters.

13. The system as claimed in any of claims 10 through 12 wherein rotation of said small knob edits the one of said parameters that are highlighted.

14. The system as claimed in any of claims 9 through 13 wherein said processor is adapted to display context dependent labels for said large and small rotary knobs.

15. The system as claimed in claim 14 wherein said processor is adapted to separately highlight each of said context dependent labels to identify which of said knobs have active functions associated with corresponding controls.

16. The system as claimed in any of claims 10 through 15 wherein said small rotary knob rotates about an axis of rotation and wherein said small rotary knob is adapted to be actuated in a direction of said axis of rotation.

17. The system as claimed in claim 16 wherein said processor is adapted to display context dependent labels for said large and small rotary knobs and said actuation of said small rotary knob in said direction of said axis of rotation.
